(19) United States
(12) Patent Application Publication
(10) Pub. No.: US 2009/0164044 A1
(43) Pub. Date: Jun. 25, 2009

(54) LOCALIAZATION SERVICE FRAMEWORK FOR ESTIMATING ROBOT POSITION AND METHOD THEREFOR

(75) Inventors: Kyu Seo Han, Daejeon (KR); Won Pil Yu, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/171,333

(22) Filed: Jul. 11, 2008

(30) Foreign Application Priority Data
Dec. 20, 2007 (KR) 10-2007-0134471

(51) Int. Cl. G06F 17/00

(52) U.S. Cl. 700/258; 901/46

(57) ABSTRACT

A localization service framework for estimating a position of a robot includes a plurality of sensors, a sensor property based localization module connected to the plurality of sensors for converting sensor data sensed by the sensors into position data of the sensors on a basis of the properties of the sensors, respectively, in response to the request of position information of the robot, and a position information combining module for combining the position data of the sensors to obtain position information of the robot, the position information of the robot being provided to the application through the localization service interface.

### CROSS-REFERENCE(S) TO RELATED APPLICATIONS

The present invention claims priority of Korean Patent Application No. 10-2007-0134471, filed on Dec. 20, 2007, which is incorporated herein by reference.

### FIELD OF THE INVENTION

The present invention relates to a localization service framework and a method for estimating a robot position.

This work was supported by the IT R&D program of MIC/IITA [2005-S-092-03, USN-based Ubiquitous Robotic Space Technology Development].

### BACKGROUND OF THE INVENTION

As is well known in the art, a function to provide various kinds of services using a robot depends on mobility of the robot. Precise position information of the robot is needed to support the mobility of the robot. In a technical term, a function to obtain position of the robot is referred to as ‘localization’. The localization is performed by obtaining and processing data related to the positions from sensors attached to the robot or installed in an environment in which the robot is moving.

The localization of the robot is classified into a relative localization and an absolute localization in relation with the reference position. The relative localization is expressed as a relative position of the robot for its current position with respect to its initial position, and is usually used to applications such as an inertial navigation. In order to obtain the relative localization, equipment such as an encoder, a gyroscope and an accelerometer sensor are used which are installed in the robot. For the absolute localization, landmarks are used, and positions of the landmarks are known in a reference frame determined in advance. The position of the robot is determined by identifying such landmarks, obtaining the positions of the landmarks and performing a position calculation from the positions. GPS (Global Positioning System) used widely is a typical example of the absolute localization, and RFID (Radio Frequency Identifier) and a network camera are used in a robot technology.

The above described localization uses different methods depending on kinds of sensors and the number of sensors, environments where the robot is moving, and functions to be performed by the robot. That is, a specific sensor can measure only one of various physical properties of a surrounding environment. Robot developers use various sensors and then provide a localization method in which properties of the sensors are complemented with one another. Therefore, an infinitely large number of localization methods can be existed, theoretically. Accordingly, an existing various software or hardware platform which provides position data has a problem in that it increases complexity in developing the localization method hereafter.

### SUMMARY OF THE INVENTION

Therefore, it is an object of the present invention to provide a localization service framework and a method for estimating a robot position, capable of selecting and using sensors used to obtain position information of a robot, uniting sensor data and combining position information based on sensor properties.

In accordance with an aspect of the present invention, there is provided a localization service framework for estimating a position of a robot, including:

a plurality of sensors;

a localization service interface for receiving a request of position information from an application;

a sensor property based localization module connected to the plurality of sensors for converting sensor data sensed by the sensors into position data of the sensors on a basis of the properties of the sensors, respectively, in response to the request of position information of the robot; and

a position information combining module for combining the position data of the sensors to obtain position information of the robot, the position information of the robot being provided to the application through the localization service interface.

In accordance with another aspect of the present invention, there is provided method for estimating a position of a robot in a localization service framework including a plurality of sensors and a plurality of sensor units connected to the plurality of the sensors, respectively, the method including:

determining one or more operable sensor units among the plurality of the sensor units in accordance with a request of location information of the robot from an application;

obtaining sensor data sensed by the sensors corresponding to the determined operable sensor unit;

converting the sensor data having different spatial coordinates into the position data of the sensors on a basis of the properties of the sensors using preset spatial coordinates; and

obtaining position information of the robot using the position data of the sensors.

### BRIEF OF DESCRIPTION OF THE INVENTION

The above and other features and advantages of the present invention will become more apparent to those of ordinary skill in the art by describing in detail embodiments thereof with reference to the attached drawings in which:

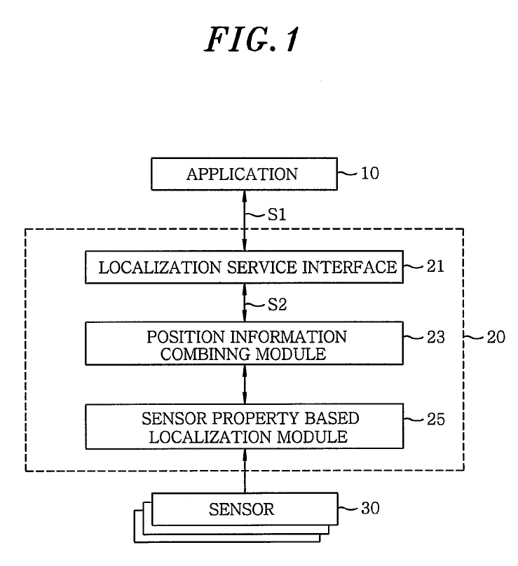

FIG. 1 is a view illustrating a localization service framework for estimating a robot position in accordance with an embodiment of the present invention.

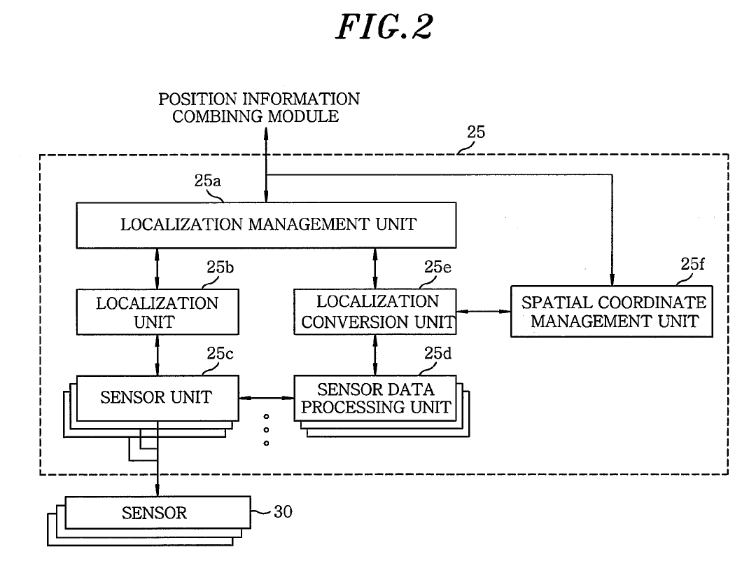

FIG. 2 is a detailed block diagram of a sensor property based localization module shown in FIG. 1.

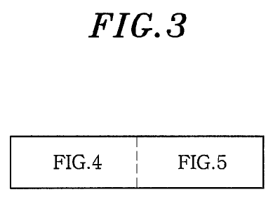

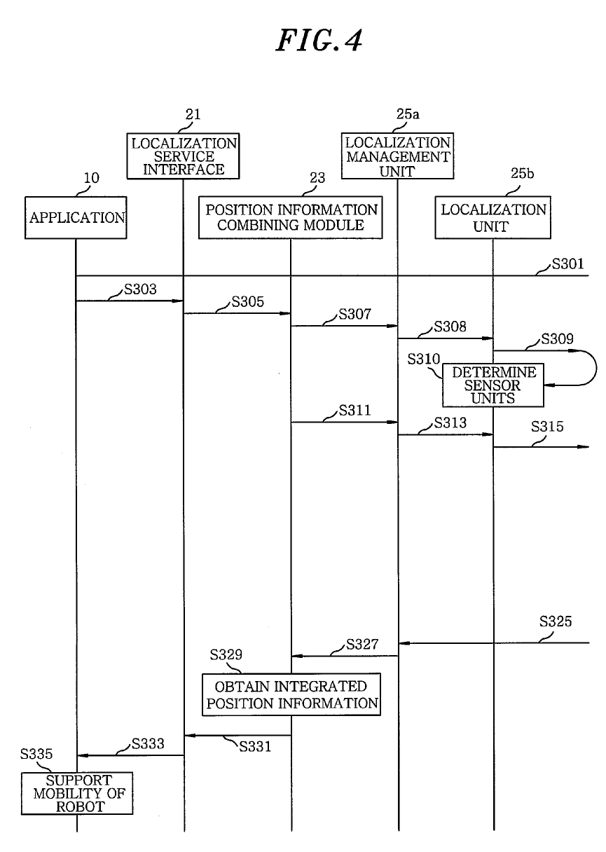

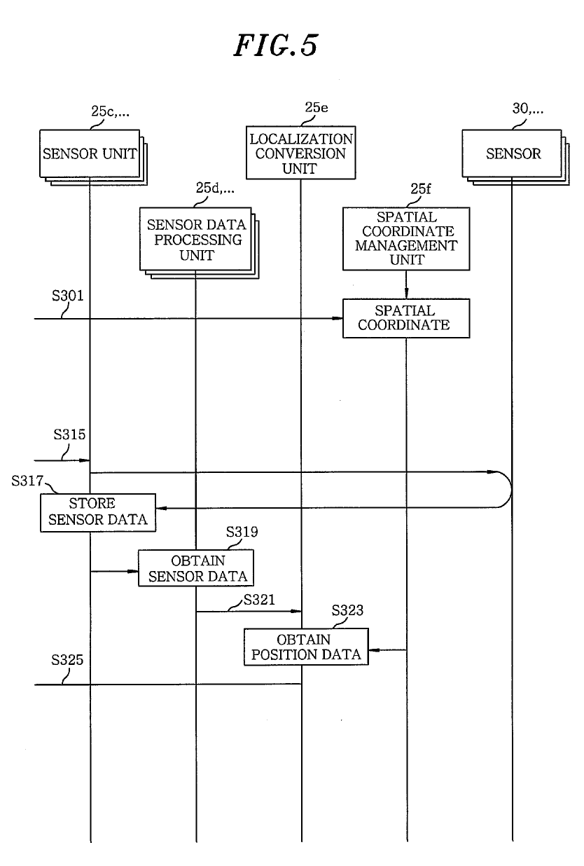

FIG. 3 is a sequence chart illustrating a method for estimating a robot position of a localization service framework shown in FIG. 1, wherein FIG. 4 shows a left portion of FIG. 3 and FIG. 5 shows a right portion of FIG. 3.

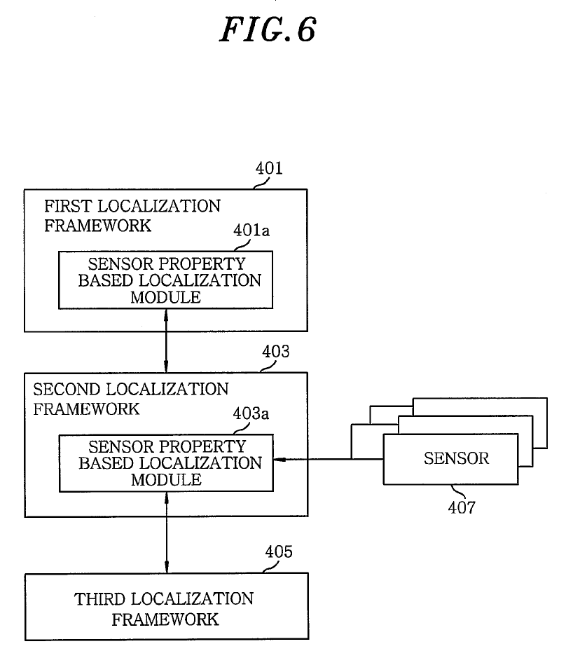

FIG. 6 is a view illustrating a plurality of service frameworks, which are connected in a hierarchical structure.

### DETAILED DESCRIPTION OF EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

FIG. 1 is a view illustrating a localization service framework for estimating position of a robot in accordance with an embodiment of the present invention.

An application 10 includes all applications which support mobility of a robot using position information of the robot. The application 10 issues a request of position information (for example, the position information of a robot) to a localization service framework 20 through a position information acquisition channel S1, and supports the mobility of the robot using the position information of the robot provided by the localization service framework 20 in response to the request of position information.

The localization service framework 20 operates as a sensor unit together with a plurality of sensors 30 connected thereto, and obtains the position information of the robot. Each sensor 30 is attached to the robot or installed in an environment in which the robot is moving. The localization service framework 20 includes a localization service interface 21, a position information combining module 23 and a sensor property based localization module 25.

The localization service interface 21 provides an interface which permits the application 10 to access the localization service framework 20. The localization service interface 21 sends the request of position information from the application 10 to the position information combining module 23 through an integrated position information acquisition channel S2. Further, the localization service interface 21 provides the position information of the robot provided by the position information combining module 23 to the application 10.

The position information combining module 23 sends the request of position information to a sensor property based localization module 25, and simultaneously queries an availability query signal to the sensor property based localization module 25 to determine the availability of the sensor property based localization module 25. Further, in accordance to the request of position information from the application 10, the position information combining module 23 combines the position information, which are based on the properties of the sensors, provided by the sensor property based localization module 25 to obtain overall position information of the robot. The overall position information of the robot is then provided to the application 10 through the localization service interface 21. In this regard, the determination of the availability of the sensor property based localization module 25 is achieved by sending an availability query signal, e.g., a specific binary digit ‘1’, to arbitrary units to be determined and selecting one or more units which return the same signal ‘1’ as that of the availability query signal as operable units.

FIG. 2 is a detailed block diagram of the sensor property based localization module 25. The sensor property based localization module 25 is connected to the plurality of sensors 30, and converts the obtained from the sensors 30 into position data of the sensors on a basis of the properties of the sensors 30. As shown in FIG. 2, the sensor property based localization module 25 includes a localization management unit 25a, a localization unit 25b, a plurality of sensor units 25c, a plurality of sensor data processing units 25d, a position information conversion unit 25e and a spatial coordinate management unit 25f.

The localization module 25b transmits the availability query signal originated from the position information combining module 23 to the plurality of sensor units 25c, and selects one or more sensor units which return the availability query signal as it is as the operable sensor units. At this time, the request of position information is provided to the operable sensor units 25c through the localization management unit 25a and the localization unit 25b.

The sensor units 25c are directly connected to the sensors 30 and the sensor data processing units 25d, respectively. The sensor units 25c have physical properties of the sensors 30 and obtain the sensor data obtained by the sensors 30, respectively. Specifically, the operable sensor units selected from the plurality of sensor units 25c obtain and store the sensor data sensed by the corresponding sensors 30 according to the request of position information provided from the localization unit 25b. The sensor data obtained by the operable sensor units 25c are then provided to the corresponding sensor data processing units 25d, respectively.

The sensor data processing units 25d retrieves the sensor data and the sensor properties stored in the sensor units 25c. The sensor data and the sensor properties retrieved by the sensor data processing units 25d are then provided to the position information conversion unit 25e.

Here, since the sensor data have spatial coordinates different with one another, it is needed to convert the different spatial coordinates into the preset spatial coordinates. The spatial coordinate management unit 25f has the preset spatial coordinates provided from the application 10 through the localization service interface 21 and the position information combining module 23.

The position information conversion unit 25e converts the different spatial coordinates of the sensor data into an integrated spatial coordinates with reference to the preset spatial coordinates stored in the spatial coordinate management unit 25f. The position data of the sensors 30 whose spatial coordinates have been converted are then provided to the localization management module 25a.

Accordingly, the present invention can easily perform selection and use of the sensors used to obtain the position information, merger of the sensor data and combination of sensor property based position information, thereby increasing compatibility of the service framework.

FIG. 3 is a sequence chart illustrating a procedure for obtaining position information of a robot using the localization service framework in accordance with the present invention, wherein FIG. 4 shows a left portion of FIG. 3 and FIG. 5 shows a right portion of FIG. 3.

First, an application 10 provides preset spatial coordinates assigned to the respective sensors 300 in advance to the spatial coordinate management unit 25f of the localization service framework 20 for storing thereof at S301.

Next, the application 10 issues the request of position information of the robot to the localization service interface 21 through the position information acquisition channel S1 at S303.

The request of position information from the application 10 is then transferred to the position information combining module 23 through the integrated position information acquisition channel S2 at S305.

The position information combining module 23 relays the request of position information to the localization management module 25a at S307. Further, the position information combining module 23, in response to the request of position information, provides the availability query signal to the localization management unit 25a at S311.

The localization management unit 25a provides the availability query signal from the position information combining module 23 to the localization unit 25b at S308. At the same time, the request of position information is also provided to the localization unit 25b at S313.

Then, the localization unit 25b transmits the availability query signal to the plurality of sensor units 25c at S309, and selects one or more sensor units which return the availability query signal as the operable sensor units at S310. Thereafter, the localization unit 25b provides the request of position information to the operable sensor units 25c which have been determined operable at S315.

Subsequently, the operable sensor units 25c obtain and store the sensor data sensed by the corresponding sensors 30 at S317.

The sensor data stored in the operable sensor system modules 25c are retrieved by the corresponding sensor data processing unit 25d, respectively, at S319 and then provided to the position information conversion unit 25e at S321.

The position information conversion unit 25e converts the sensor data having different spatial coordinates from the sensor data processing units 25d into the integrated spatial coordinates using the preset spatial coordinates in the spatial coordinate management unit 25f, thereby obtaining position data matched to the properties of the sensors at S323.

The position data obtained by the position information conversion unit 25e is then provided to the localization management unit 25a at S325.

According to the request of position information, the localization management unit 25a provides the position data from the position information conversion unit 25e to the position information combining module 23 at S327.

The position information combining module 23 combines the position data provided from the localization management unit 25a to obtain the integrated position information of the robot in accordance with the request of position information at S329. The integrated position information of the robot is then provided to the application 10 through the localization service interface 21 at S331 and S333.

Accordingly, the position of the robot is estimated and the application 10 supports the mobility of the robot using the position information of the robot received through the localization service interface 21 at S335.

FIG. 6 is a block diagram illustrating service frameworks which are connected in a hierarchical structure in accordance with another embodiment of the present invention.

Position information provided by a third localization service framework 405 can be connected to a sensor property based localization module 403a of a second localization service framework 403. In this case, properties of sensors 407, . . . which are stored in a sensor system module in the sensor property based localization module 403a are the same as those of the third localization service framework 405. In addition, the sensor data obtained by the second localization service framework 403 are the same as position information of the third localization service framework 405.

Further, the sensor property based localization module 403a of the second localization service framework 403 provides the position information input from the third localization service framework 405 and the position information obtained using the sensor data input from the sensors 407, . . . to the sensor property based localization module 401a in a first location service framework 401.

In other words, although the first localization service framework 401 does not maintain sensors, the first localization service framework 401 can provide the position information which is provided from the sensors 407 connected to the sensor property based localization module 403a as its position information.

Furthermore, each of the localization service frameworks 401, 403 and 405 can be constructed on the same platform, or on the different platforms, respectively. Even in the case that the frameworks exist on the different platforms, position information of the robot can be separately provided regardless of their positions. Accordingly, it is possible to increase flexibility of the framework and to prevent the framework to be complicated.

As described above, the present invention is capable of selecting and using sensors used to obtain position information of a robot, uniting sensor data and combining position information based on sensor properties with ease, thereby increasing compatibility of the service framework.

Further, the present invention can use a localization service framework in the same manner as a sensor, and therefore obtain position information of a robot using sensor data which does not exist in the localization service frame used currently.

While the invention has been shown and described with reference to certain exemplary embodiments thereof, it will be understood by those skilled in the art that various changes in form and details may be made therein without departing from the scope of the invention as defined by the appended claims.

What is claimed is:

1. A localization service framework for estimating a position of a robot, comprising:
a plurality of sensors;
a localization service interface for receiving a request of position information from an application;
a sensor property based localization module connected to the plurality of sensors for converting sensor data sensed by the sensors into position data of the sensors on a basis of the properties of the sensors, respectively, in response to the request of position information of the robot; and
a position information combining module for combining the position data of the sensors to obtain position information of the robot, the position information of the robot being provided to the application through the localization service interface.

2. The localization service framework of claim 1, wherein the sensor property based localization module includes:
a plurality of sensor units connected to the plurality of sensors for storing physical properties of the sensors and the sensor data sensed by the sensors, respectively;
a localization unit for determining one or more operable sensor units among the plurality of the sensor units;
a plurality of sensor data processing units, connected to the plurality of sensor units, respectively, for retrieving the sensor properties and the sensor data from the operable sensor units, respectively; and
a position information conversion unit for converting the sensor data having different spatial coordinates into the position data of the sensors using preset spatial coordinates, and providing the converted position data to the position information combining module.

3. The localization service framework of claim 2, wherein the position information combining module queries an availability query signal to the sensor property based location module in order to determine the operable sensor units, in response to the request of the position information.

4. The localization service framework of claim 3, wherein the localization unit transmits the availability query signal from the position information combining module to the respective sensor units, and selects one or more sensor units which return the same signal as the availability query signal, the selected sensor units being determined as the operable sensor units.

5. The localization service framework of claim 4, wherein the preset spatial coordinates are set by the application, and
wherein the sensor property based localization module further includes a spatial coordinate management unit for storing the preset spatial coordinates.

6. The localization service framework of claim 1, wherein the localization service framework is constructed to support a hierarchical structure in which a plurality of localization service frameworks are hierarchically connected to so that the position data of the sensors is obtained from a high ranked localization service frame work.

7. The localization service framework of claim 6, wherein each of the localization service frameworks is constructed on the same platform or on different platforms.

8. A method for estimating a position of a robot in a localization service framework including a plurality of sensors and a plurality of sensor units connected to the plurality of the sensors, respectively, the method comprising:
determining one or more operable sensor units among the plurality of the sensor units in accordance with a request of position information of the robot from an application;
obtaining sensor data sensed by the sensors corresponding to the determined operable sensor unit;
converting the sensor data having different spatial coordinates into the position data of the sensors on a basis of the properties of the sensors using preset spatial coordinates; and
obtaining position information of the robot using the position data of the sensors.

9. The method of claim 8, determining one or more operable sensor units comprising:
querying an availability query signal for determining the operable sensor units to the plurality of the sensor units, in response to the request of the position information.

10. The method of claim 9, wherein one or more sensor units which return the same signal as the specific signal is determined as the operable sensor units.
